(19) United States
(12) Patent Application Publication
(10) Pub. No.: US 2024/0322902 A1
(43) Pub. Date: Sep. 26, 2024

(54) SATCOM TERMINAL AND METHOD FOR CONVEYING INHERENT COMMAND AND CONTROL DATA TO A RECEIVING NODE

(71) Applicant: Elta Systems Ltd., Ashdod (IL)

(72) Inventors: Itai BAR ZIV, Gedera (IL); Itay FUCHS, Nes Ziona (IL)

(21) Appl. No.: 18/594,297

(22) Filed: Mar. 4, 2024

(30) Foreign Application Priority Data
Mar. 22, 2023 (IL) 301573

(51) Int. Cl. H04B 7/185; H04W 28/08

(52) U.S. Cl. CPC H04B 7/18584; H04B 7/18506; H04W 28/0967

(57) ABSTRACT

Supplemental data including location of a mobile platform is provided to a receiving node via a satellite without requiring either a third-party dedicated command and control data system or a dedicated channel for command and control data. Real-time spatial location of the mobile platform is obtained at a transceiver either directly from a pointing antenna or from a navigational system (EGI) coupled to a platform bus. For each transmission time-slot allocated by the transceiver for transmitting data pertaining to a SATCOM service and for which the SATCOM service awaits transmission, the transceiver determines whether there is available bandwidth for transmitting the supplemental data together with data pertaining to the SATCOM service. If so, the supplemental data is transmitted together with the data pertaining to the SATCOM service; otherwise, if, for any given time-slot, no data pertaining to the SATCOM service awaits transmission, the supplemental data is transmitted on its own.

### RELATED APPLICATION

This application claims priority from Israel Patent Application No. 301573 filed Mar. 22, 2023, the contents of which are incorporated herein by reference in their entirety.

### FIELD OF THE INVENTION

This invention relates to mobile satellite communication systems.

### BACKGROUND OF THE INVENTION

There are many applications, both military and civil, where mobile platforms are required to communicate with a fixed ground station and to convey to the ground station their instantaneous location in space in real time. One well-known civilian application is flight tracker of which there are many variants, but all of which serve to allow anyone having access to the application to track the flight of a civilian airplane. In order for such applications to operate, the airplane needs to convey its instantaneous location to a ground station, typically a server operated by the application service provider for onward relaying to client platforms such as computers, smartphones and the like. The airplane does not communicate directly to the ground station, but typically relays its location to a geostationary satellite although it is also known to use Low Earth Orbit satellites, which then relays the information including location, flight ID and so on to the ground station. To this end, both the ground station and the airplane need to be oriented toward the satellite. In the case of the ground station, which is commonly fixed in space and therefore stationary, the required directionality is established during installation and remains intact. Although the ground station is not itself a feature of the present invention, it should be noted for the sake of completeness that ground stations also exist that are capable of directing motorized antennas from one satellite to another, as well as mobile ground stations, which are maintained static once a link is established. In the case of the airplane which is constantly moving in space, the aircraft antenna must constantly be pointed toward the satellite.

In this example, the aircraft is merely an example of a mobile platform, and it will be understood that the same considerations apply to any mobile platform such as ships, road vehicles and indeed any other moveable asset whose location needs to be tracked in real time.

SATCOM systems are communication systems commonly comprising one or more static or mobile terminals and a ground hub, communicating through a satellite. SATCOM terminals, static or mobile, commonly comprise the following elements:
1) Modem
2) Block upconverter (BUC)/Power Amplifier. A block upconverter is used in the transmission (uplink) of satellite signals to convert a band of frequencies from a lower frequency to a higher frequency.
3) Antenna
4) Controller for the antenna and BUC/Power amplifier. Typically, the controller is a sub-module of the modem but not necessarily.

The main difference between static and mobile SATCOM terminals is the complexity of the antenna. Static systems require only a single installation to be pointed to a desired/selected satellite, e.g., SATCOM antennas on rooftops which can be seen almost on any building in the world pointing at geostationary satellites. Mobile systems require either motorized or electronically steerable antennas capable of changing their pointing angles according to real time calculation of their geo-location/orientation in relation to the satellite position. An example of such an antenna is one installed on top of an airplane providing a SATCOM link with a satellite throughout the entire journey of the airplane regardless of its maneuvers. The antenna in a mobile SATCOM terminal must use the following real time parameters in order to compute and point at the satellite:
1. Self geo-position (Longitude, Latitude, Altitude)
2. Self-orientation (Heading/Yaw, Pitch, Roll), and may also require self-orientation dynamics (Heading/Yaw change rate, Pitch change rate, Roll change rate).
3. Satellite location indicated by longitude for geostationary satellites; and by longitude, latitude and altitude for non-geostationary satellites and the satellite trajectory.

The first two parameters can be received either by external sources to the SATCOM terminal such as EGI-Embedded GPS/INS from the airplane by an ARINC™ interface, MIL-STD-1553 interface or alike; or by internal resources if the SATCOM antenna includes internal navigation means such as a gyroscope system, compass and so forth. ARINC is a trademark of ARINC Incorporated, Maryland, USA. Satellite location may be predefined or selected by the operator along with other parameters required for the line (e.g., uplink frequency, downlink frequency, satellite transponder polarization).

For mobile SATCOM terminals, the above three parameters are mandatory to establish a sustainable SATCOM link unless a so-called “tracking” antenna is used, which tracks the received signal in order to optimally direct the antenna toward the satellite.

Modern conventional military (and some civilian) platforms, whether airborne, naval or land, utilize a standalone C4I system which may be interfaced to any on-board communication systems e.g., VHF, UHF, SATCOM, etc. C4I (alternatively written C⁴I) is an acronym for command, control, communications, computers, intelligence and is sometimes abbreviated to C2: command and control. A C4I system has the following major roles:
1. Process received information from different sources:
   a. Own: On-board sources such as platform navigation, fuselage levels, ammunition status, health status, radar targets, EW targets, etc.
   b. Remote: Information from other “friendly” platforms (by means of incoming communications);
2. Send the above information, either raw or processed, to other friendly node(s) or to a Hub (where relevant);
3. Present the operator with raw or processed information in a readable visual manner (such as live map) created either from its own source or from another friendly node(s) or Hub (where relevant) or any suitable combination;

The on-board interfaces between the C4I system and the various on-board communication systems to send and/or receive C4I information may be based on layer 3 and/or above using interfaces such as IPV4, UDP, TCP (as shown in FIG. 4) without derogating from information communicated on lower layers using interfaces such as LAN, serial lines, BUS and so forth. The C4I system does not have any impact on the method of RF communication which is defined solely by the characteristics of the communication systems. Thus, for example, HF will provide low throughput communications, UHF will provide communications only for short range, SATCOM will provide high latency and so forth.

C4I systems are highly sophisticated systems that may be integrated with the platform structure during manufacture according to demanding end-user specifications, that typically include cyber security features among other features that are specific to the desired end-use of the host platform. However, common to all C4I systems are embedded navigation instruments such as INS and gyroscopes that permit internal navigation of the host platform and communication to external devices. To this end, SATCOM modems may be configured to receive the navigation data for relaying to external platforms via a geostationary satellite.

However, not all mobile platforms are equipped with C4I or C2 capability. One example might be a land vehicle or a yacht or small ship navigated by a crew or a sporting enthusiast. Tracking of such devices is currently limited to GPS or equivalent tracking where ships, for example, and other mobile vessels convey their locations as determined by in-board GPS or equivalent units to a land/earth station that relays the ship's ID and location to a tracking station.

It should be noted that the manner in which geo-position is determined is not a feature of the invention and is not restricted to use of GPS or equivalent satellite-based systems. There are alternative methods for determining geo-position that do not rely on satellites although they are typically less accurate than satellite-based positioning systems and may not be available in all locations. Some of these methods include:

Terrestrial-Based Systems: Systems like the Global Positioning System (GPS) can also use signals from terrestrial-based stations to determine position.

Dead Reckoning: Dead reckoning involves determining geo-position by keeping track of local movements and calculating the resulting change in position using devices such as a compass, odometer, or accelerometer.

Wireless Local Area Network (WLAN) Positioning: This involves using the signal strength of nearby Wi-Fi access points to determine geo-position.

Cell Tower Triangulation: Cell tower triangulation involves determining geo-position based on the signal strength from multiple nearby cell towers.

Bluetooth Low Energy (BLE) Beacons: BLE beacons are small, low-power devices that emit a Bluetooth signal. By determining the signal strength from multiple BLE beacons, which may themselves be mobile and are located within short-range propagation of the mobile platform, it is possible to determine geo-position.

The present invention is more particularly directed to mobile platforms that are equipped with directional antennas that point toward a geostationary satellite. Automatic pointing satellite dishes typically utilize gyroscopes, GPS position sensors, and unique satellite identification data to aid in identification of the satellite that it is pointing at. The dishes are typically articulated to pan/tilt mechanisms driven by stepper motors to aim the dish and employ gyroscopes to detect changes in position while the vehicle is in motion. Precision encoders are used to automatically direct the antenna with high accuracy. Gyroscopes and inertial navigation systems sense movement of the mobile platform and relay signals to a controller, which feeds error signals to the actuator motors for moving the antenna and maintaining alignment with the satellite. Auto-tracking antennas may include integral actuators and sensors to track a satellite based on the known location of the satellite in space or may be coupled to external sensors to this end. In all cases, a controller relays navigation signals to the antenna to maintain its alignment with the satellite during movement of the mobile platform. It thus emerges that at all times the antenna's sensors produce navigation signals that indicate its location and orientation in space. More specifically, pointing antennas typically comprise a satellite dish mounted on a pedestal that is fixedly attached to the mobile platform. The dish is rotatable about two axes (yaw and pitch) so as to be directed to a satellite of known location in space. Alternatively, the antenna beam may be electrically steerable, using a phased array.

More generally, pointing antennas may receive navigation signals from external guidance sensors, which sense movement of the mobile platform and convey signals to the antenna's actuators or to the phased array in the case of electrically steerable antennas.

Regardless of whether the antenna is auto-pointing or guided by external navigation systems, the location of the mobile platform is the same as that of the antenna's pedestal and is unaffected by the orientation of the satellite dish. Consequently, if an auto-tracking antenna is employed, the real-time location in space of the mobile platform will be the three spatial coordinates of the antenna, i.e., latitude, longitude and altitude. If an externally guided antenna is used, these coordinates will be derived from an on-board navigation system and conveyed to the antenna. In either case, although the spatial location of the mobile platform is known or is easily derived, there appears to be no suggestion in the art to convey it together with or perhaps instead of a SATCOM modem's payload on the back of conventional data pertaining to a service provided by the SATCOM system.

U.S. Pat. No. 9,553,658 discloses a satellite-ready Satcom Direct router with simultaneous use of Inmarsat, Swift Broadband, Swift 64, Ku-Band and Ka-Band satellite connections with intelligent traffic control, along with Wi-Fi access and 3G/4G cellular network connectivity.

A router connects communication devices to each other and, in hard-wired installations, to a modem. The modem demodulates signals received from a communications network to derive signals that local devices can use, and vice versa. The router connects to the modem and then to local devices such as computers, printers, and other peripheral devices via either an Ethernet cable or, in the case of a wireless router, Wi-Fi signal to form a local area network (LAN), allowing devices to share files and peripherals like printers. However, a router does not need to connect to a modem to function, since a LAN can operate without Internet access. In contrast, a modem is a device that connects devices in a local network to a remote network, such as, but not only, the Internet. The modem takes signals from the remote network service provider and translates them into signals that local devices can use, and vice versa.

The router in U.S. Pat. No. 9,553,658 interfaces with different hosts to provide services on the one hand, using various internal communication standards such as Wi-Fi, LAN, Cellular 3G/4G/5G, etc., while on the other hand interfacing various SATCOM modems for long range communication. It cannot provide services including C2 capabilities to remote clients without interfacing to a SATCOM system via modems. The router does provide a moving map of the aircraft but it relies on an ARINC interface or any other EGI interface from the aircraft to obtain navigational data.

### SUMMARY OF THE INVENTION

It is an object of the invention to convey spatial location data of a mobile platform together with or instead of a SATCOM modem's payload on the back of conventional data pertaining to a service provided by the SATCOM system.

To this end there is provided in accordance with an aspect of the invention a method for providing supplemental data including real-time spatial location of a mobile platform to a receiving node via a satellite without requiring either a third-party dedicated command and control data system or a dedicated channel for command and control data, the method comprising:
(a) obtaining at a transceiver the real-time spatial location of the mobile platform either directly from a pointing antenna or from a navigational system (EGI) coupled to the platform bus;
(b) for each transmission time-slot allocated by the transceiver for transmitting data pertaining to a SATCOM service, determining whether data pertaining to the SATCOM service awaits transmission; and if so:
   i) determining whether there is available bandwidth for transmitting the supplemental data together with data pertaining to the SATCOM service;
   ii) if there is sufficient available bandwidth, transmitting from the transceiver the supplemental data together with the data pertaining to the SATCOM service; and
(c) if, for any given time-slot, no data pertaining to the SATCOM service awaits transmission, then transmitting from the transceiver the supplemental data on its own.

In accordance with another aspect of the invention, there is provided a mobile satellite communication (SATCOM) terminal providing supplemental data including real-time spatial location of a mobile platform to a receiving node via a communications satellite without requiring a third-party dedicated command and control data system or a dedicated channel for command and control; the SATCOM terminal comprising:
a transceiver for transmitting and receiving data pertaining to a SATCOM service,
the transceiver including a modem configured to modulate an outgoing RF carrier signal with data to be relayed to the communications satellite and to demodulate a received RF signal to extract data relayed by the communications satellite, and
a connector for coupling to the modem a pointing antenna for pointing toward the communications satellite;
the transceiver further including a controller coupled to the modem and to the platform bus and being configured to:
   (a) determine for each transmission time-slot, determining whether data pertaining to the SATCOM service awaits transmission, and if so:
      i) determine whether there is available bandwidth for transmitting the supplemental data of the platform together with data pertaining to the SATCOM services;
      ii) if there is sufficient available bandwidth, transmit from the transceiver the real-time supplemental data together with the data pertaining to the SATCOM service; otherwise:
   (b) if, for any given time-slot, no data pertaining to the SATCOM service awaits transmission, then transmit from the transceiver the real-time spatial location on its own.

Some embodiments exploit the existence of an auto-pointing antenna's sensor signals to allow a SATCOM terminal to provide command and control data to a receiving node via a communication satellite without requiring a third-party dedicated command and control data system, and without requiring a dedicated channel for command and control and without requiring an external navigation system. Other embodiments receive the navigation signals from a navigation system and convey the location data to the SATCOM modem for combining with the SATCOM system's regular payload or, if at any given time there is no payload awaiting transmission, the location data can be transmitted on its own. In some embodiments, the location is transmitted together with an ID of the mobile platform, thus providing conventional C2 signals but without the need for a third-party dedicated command and control data system, and without requiring a dedicated channel for command and control.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram showing interconnection of a typical prior art on-board platform system;

FIG. 2 is a block diagram showing an enhanced on-board SATCOM system having additional functionality according to the invention;

FIG. 3 is a block diagram showing a detail of the SATCOM system configured to transmit C2 information with or instead of the payload communication;

FIG. 4 is a pictorial representation of the 7-layer Open Systems Interconnection model (OSI model);

FIGS. 5a and 5b are a pictorial representation showing transmission of command and control data in different layers of the OSI model;

FIG. 6 is a pictorial representation showing a modification to the layer-2 header of the OSI model according to an embodiment of the invention, whereby C2 information may be transmitted without the overhead of higher OSI layers; and

FIGS. 7a and 7b are a flow chart showing operation of a controller used in the SATCOM system according to an embodiment the invention.

### DETAILED DESCRIPTION OF EMBODIMENTS

In the following description of some embodiments, identical components that appear in more than one figure or that share similar functionality will be referenced by identical reference symbols.

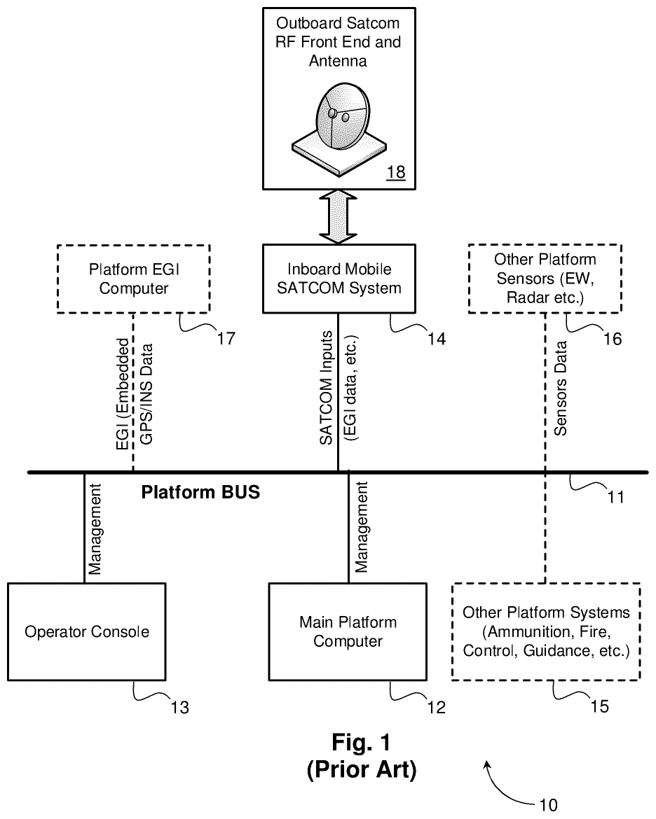

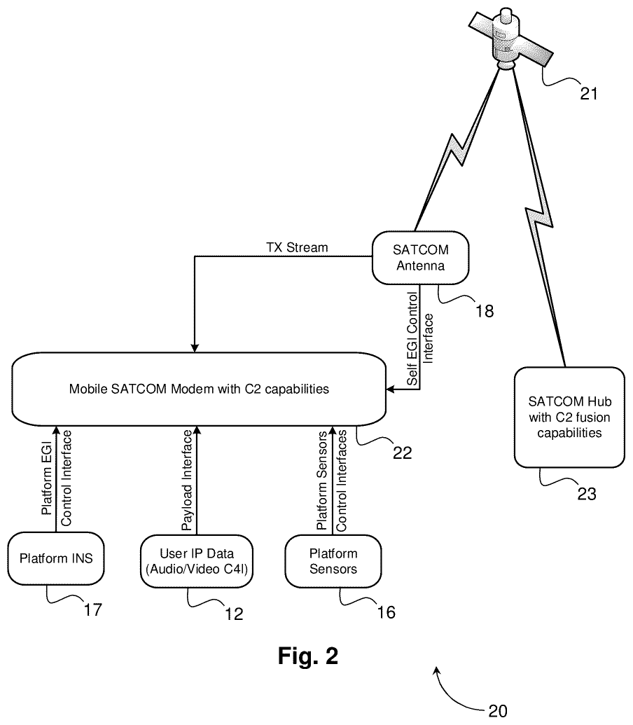

FIG. 1 is a block diagram showing interconnection of a typical prior art on-board platform system 10 having a platform bus 11 to which there is coupled a main computer 12, an operator console 13 and an inboard mobile SATCOM system 14. There may, optionally, also be coupled to the platform bus 11 other systems shown in dotted outline depending on the end-use to which the mobile platform 10 is intended. These may include systems 15 such as ammunition, fire, control, guidance, sensors 16, and an EGI computer 17. An antenna 18 is operatively coupled to the SATCOM system 14 for receiving therefrom RF data for transmission to a satellite 21 (shown in FIG. 2), which may be geostationary or non-geostationary and for receiving RF data from the satellite. If the antenna 18 is auto-pointing, it will have its own integral INS and gyro sensors that are responsive to a known location and orientation of the satellite conveyed via the platform bus 11 using the operator console 13 for auto-pointing or electrically steering the antenna toward the satellite. Alternatively, the antenna 18 may respond to real time location of the platform provided by the platform EGI computer 17 in combination with the known location and orientation of the satellite for pointing the antenna toward the satellite. At least for the purpose of the present invention, the EGI computer 17 is not required if the antenna 18 is auto-pointing.

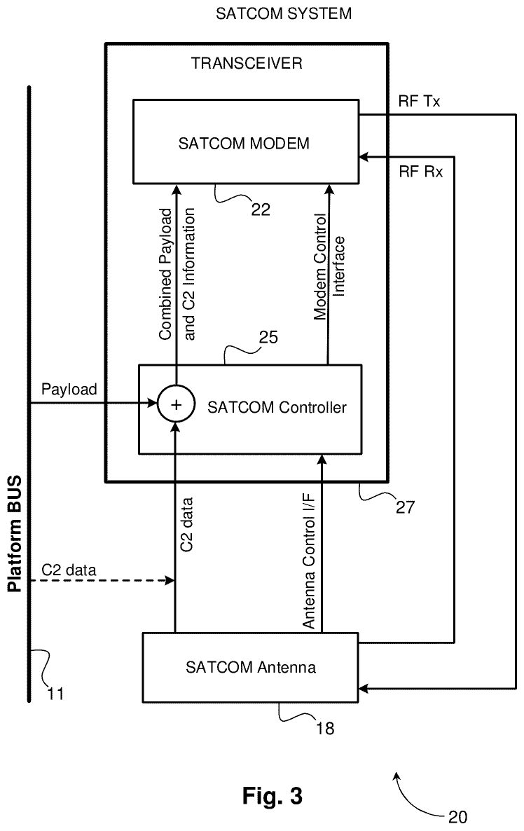

FIG. 2 is a block diagram showing a SATCOM system 20 according to an embodiment of the invention configured to transmit control and command data, combined with or instead of the payload communication. At the heart of such a system is an enhanced mobile SATCOM modem 22 whose functionality is described below with reference to FIG. 3 of the drawings. By way of example, the modem 22 receives navigation data from the EGI computer 17 shown in the figure as the platform INS (Inertial Navigation System). Although this is shown as the same bus as the platform bus 11, there may be a separate navigation bus to which an Inertial Navigation System is connected. The modem 22 also receives data from the platform sensors 16 (if provided) and user IP data from the main computer 12. To this end, it is assumed that the main computer 12 runs a user program by means of which data is conveyed to a ground hub 23 via the satellite 21. For example, in the flight tracker application to which reference was made previously, an airplane periodically sends to the ground hub its ID and location, thereby allowing ground-based users to track the flight in real time. In this case, of course, the service provided by the SATCOM system is limited to the C2 data; but more generally the service may embrace additional functionality. For example, the SATCOM system may be configured to allow a pilot to communicate vocally with the ground hub, or to send and/or receive video images etc. It may be configured to interact with on-board sensors and actuators and to convey data relating thereto to the ground hub. The actual service supported by the SATCOM system is not itself a feature of the present invention; what is important, though, is that on the back of data that is in any case transmitted from the mobile platform to the ground hub, there is also transmitted real time data indicative of at least the location in space of the mobile platform and optionally an ID of the mobile platform. In other words, the C2 data is transmitted as an optional by-product of the service that is, in any case, being provided by the SATCOM service without the need for a dedicated channel or hardware.

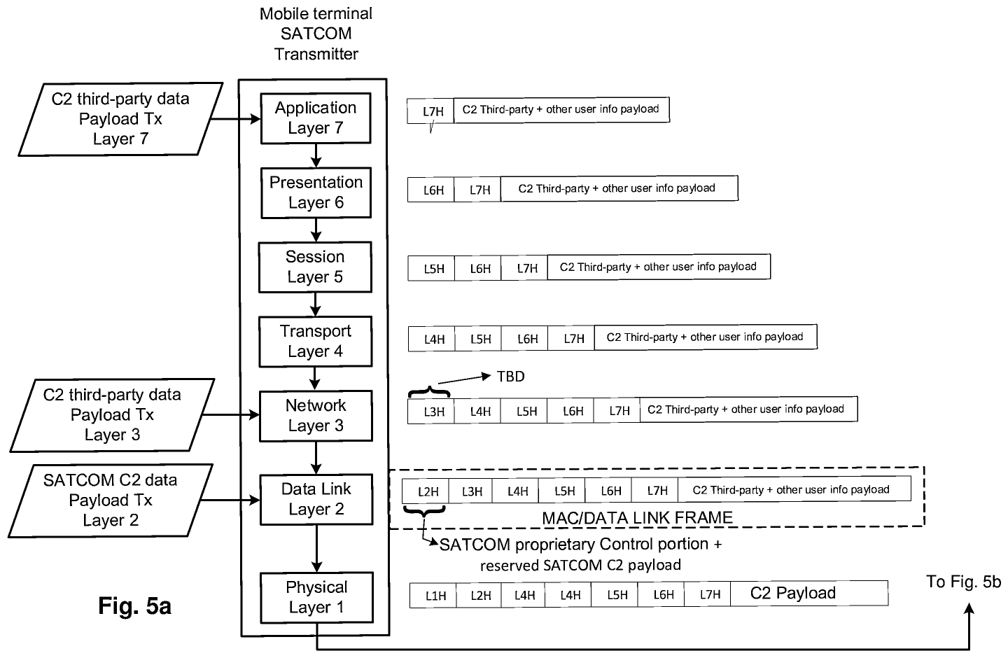

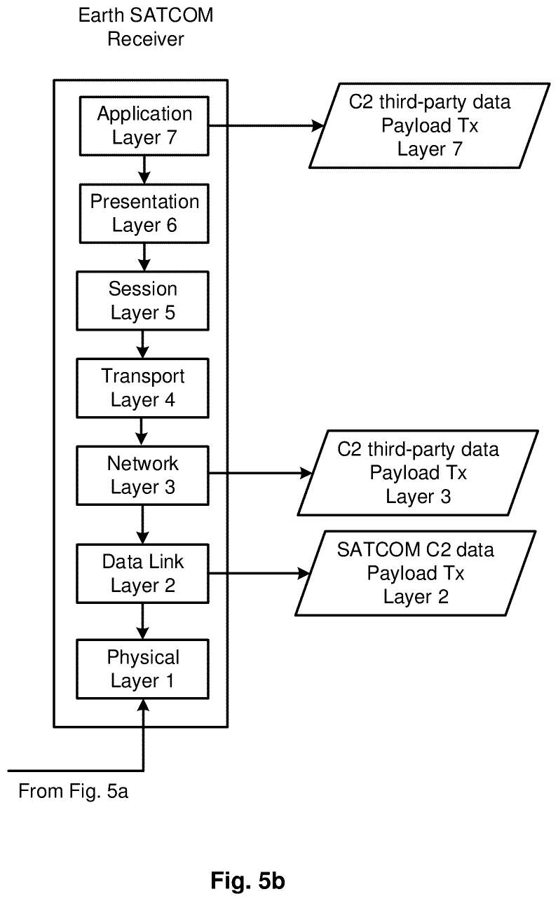

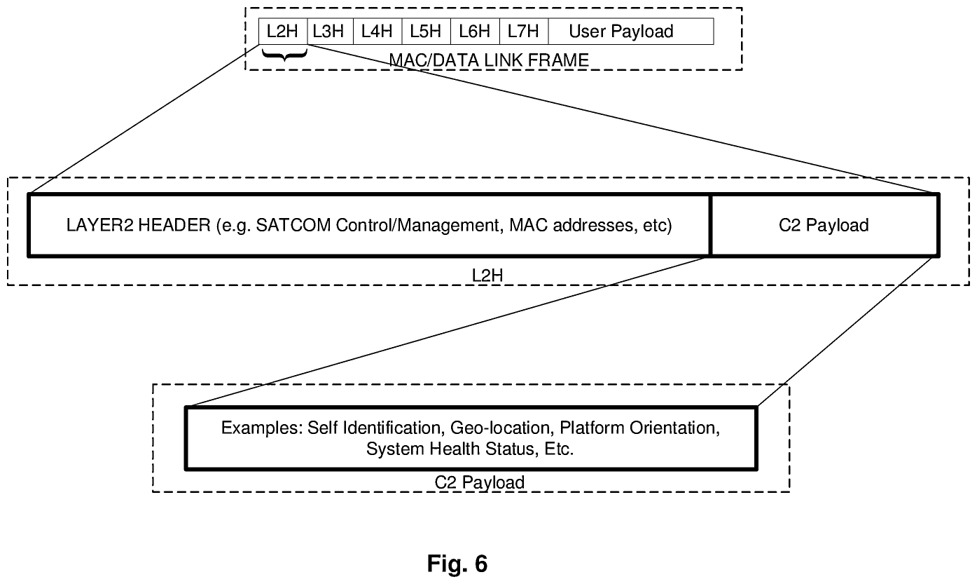

FIG. 3 is a block diagram showing a detail of the SATCOM system 20 in accordance with an embodiment of the invention configured to transmit C2 information with or instead of the payload communication. A SATCOM controller 25 is coupled to the SATCOM antenna 18, which for the purpose of illustration is assumed to be auto-pointing. To this end, the antenna 18 periodically conveys its location in real time to the SATCOM controller 25, which relays it to the satellite modem 22. The satellite modem 22 in combination with the SATCOM controller 25 together constitute a transceiver 27. The SATCOM controller 25 interfaces with both the antenna 18 and the modem 22 and receives control data from the antenna 18 and conveys control data to the modem 22. Optionally, the SATCOM controller 25 may provide a user-interface allowing the user to enter control parameters, which may include QoS (Quality of Service) that establishes a minimal bandwidth that must be allocated for the payload. The user-interface can be realized by the user console 13 shown in FIG. 1, by means of which a user can interact with the SATCOM controller 25 via the platform bus 11. Alternatively, the minimal bandwidth may be set discretely. In either case, the SATCOM controller 25 receives the payload via the platform bus 11 and the C2 data from the auto-pointing antenna 18 and uses the known bandwidth of the communication channel to determine whether there is sufficient bandwidth to transmit the payload and the C2 data together. The required bandwidth is equal to Packet Size×Packets Per Second. The controller knows the total available bandwidth of the channel and can therefore determine if there is sufficient bandwidth to transmit the C2 data with the payload. If so, the SATCOM controller 25 combines the payload data and the C2 data to form a combined data signal, which it feeds to the SATCOM modem 22, which modulates the data onto an RF carrier and feeds it to the antenna 18. If the controller determines for any given transmission time slot that there is no payload data, then the C2 data can be transmitted on its own. For the sake of completeness, if the antenna 18 is not auto-pointing, then the location and orientation of the mobile platform is determined by the platform EGI computer 17 (shown in FIG. 1), which in this case, of course, is no longer optional. In this case, the C2 data is fed to the SATCOM controller 25 from the platform bus 11 instead of the antenna 18 and is transmitted as a user payload in OSI Layer 2 or higher. For the sake of abundant clarity, we will describe OSI in more detail below with reference to FIGS. 5 and 6 of the drawings.

It should further be noted that for ease of explanation, we refer to payload as relating to the service provided by the SATCOM service provider, typically audio and video data. However, the payload may also include other information, such as sensor signals, warnings, and so on. In mobile platforms having a standalone C4I system, the payload may already include command and control data, in which case the added value of conveying command and control data derived from an auto-pointing antenna would be way of a backup in the event of a failure in the C4I system. We relate in more detail to the nature of payload in the following section.

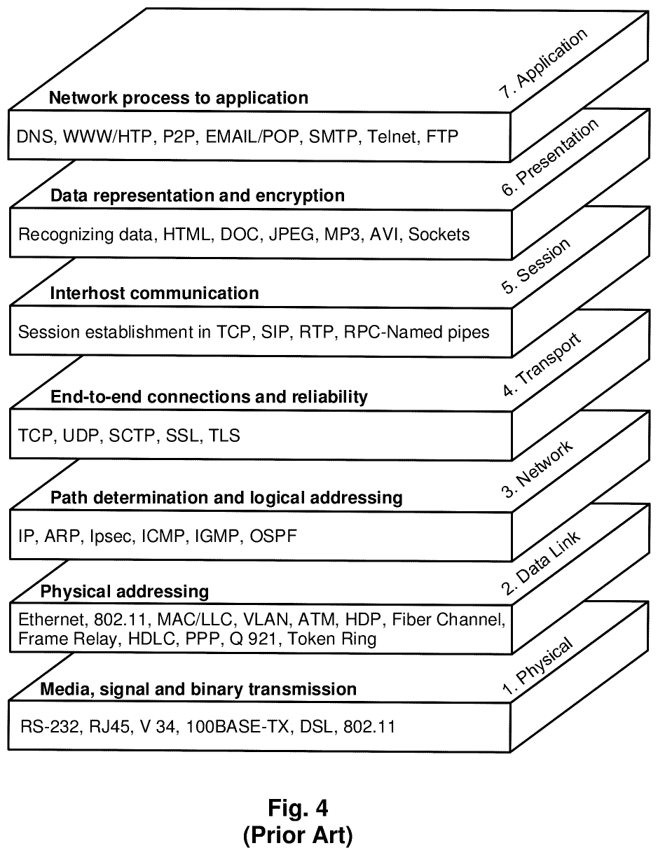

In accordance with an embodiment of the invention, the C4I information may be delivered as part of SATCOM system datalink layer (Layer 2 of the OSI model) where the information and the update rate are customized to be efficiently transmitted using the SATCOM control payload instead of the conventional data payload layers (Layer 3 or above). In the OSI (Open Systems Interconnection) reference model, the communications between a computing system are split into seven different abstraction layers: Physical, Data Link, Network, Transport, Session, Presentation, and Application as shown pictorially in FIG. 4. For ease of explanation, these layers were color-coded in the priority document IL 301573 using (for the most part) different colors as follows:
Layer 1: Physical—Blue
Layer 2: Data Link—Light Green
Layer 3: Network—Purple
Layer 4: Transport—Red
Layer 5: Session—Yellow
Layer 6: Presentation—Light Blue
Layer 7: Application—Green

There is no significance to these colors other than to distinguish between the seven layers and to correlate visually with the data headers associated with each layer shown pictorially in FIGS. 5a, 5b and 6. In jurisdictions that do not allow the filing of color images, we will omit the color coding from these figures and the reader can retrieve the original drawings by accessing the Israel Patent Office website.

Layer 2 stores information pertaining to the sending node and the receiving node. For example, the sending node would be the SATCOM modem while the receiving node would be the Ground HUB modem. It will not have information such as routing (which is stored in Layer 3), which may include the originator of the payload (e.g., aircraft computer) and the final destination (e.g., Terrestrial C2 computer). Layer 2 may also store control/management information of the physical link (e.g., bandwidth allocation, power control, RF signal sensing information to be transmitted back to the sender). Because it does not store a user payload, Layer 2 is “slim”. C2 information may also be slim (a few bytes to send geo-position) which usually will have no or very little impact on the overall bandwidth.

FIGS. 5a and 5b are a pictorial representation showing transmission of command and control data in different layers of the OSI model. Thus, conventionally, C2 third-party data and the payload are both transmitted in Layer 7, i.e., the application level, which is the highest level of the OSI model and, while the most versatile, imposes the greatest overhead. Another possible approach is to transmit both the C2 third-party data and the payload in the header of Layer 3, i.e., the network layer. This imposes significantly less overhead than Layer 7.

FIG. 6 is a pictorial representation showing a modification to the Layer-2 header of the OSI model according to an embodiment of the invention.

### Brief Explanation of the Differences Between CONTROL and DATA Information

A. It is common to divide transmitted payload into two parts:
1) DATA—The part which is sent with actual payload information such as C2/C4I from one end to the other. It is important to note that when we use the term ‘command and control data’, the ‘control data’ in this context is payload data and is distinct from the control information contained within the headers of all transmissions as explained below.
2) CONTROL—Information which will not be transmitted over the air, for example a command to mute/un-mute the transmission will go from the controller to the antenna/modem/BUC but will not be transmitted to the other end. Another example is the status information provided by the antenna to the controller such as its current pointing angles (Az/El/Pol), which are not transmitted to the receiving end. The control information may also include headers, which are used to encapsulate/extract the next layers of communication. Headers exists in every layer. Therefore, headers may be regarded as “Control” or “Data” depending on the layer itself. Typically, a Layer 2 header is “control” while Layer 3 and above headers are more related to “Data”. The CONTROL information does not include any DATA payload.

B. Therefore, the payload sent from one end to another depends on the availability of the link, the priority/QOS of the payload itself in comparison to other payloads. The radio may not be servicing only the C4I system; for example, it can serve a video/audio streaming service, and so forth.

C. Layer 3 and above are mandatory for DATA transmission, they may also include part of the CONTROL information, e.g., IP addresses of the sender and the receiver required for the routing.

D. Layer 2 is purely CONTROL information and conventionally does not include any DATA information.

This embodiment is based on the following facts:
1. The SATCOM system Layer 1 and Layer 2 are proprietary (these layers are commonly referred as SATCOM MODEM). The invention thus facilitates definition of the Layer 2 protocol by the manufacturer of the transceiver to accommodate additional information as required. This provides the flexibility to “hitchhike” on the Layer 2 and encapsulate data that actually is not normally part of the Layer 2 data.
2. The SATCOM system contains the following information required for its own operation:
   A. Geo-position
   B. Platform orientation
   C. Self-identification
3. The above information may also be referred as basic C2 information. More generally, within the context of the appended claims, the term “supplemental data” refers to any non-user payload that includes real-time spatial location of the mobile platform. It may optionally also include an ID of the mobile platform and it may optionally also include extended data as defined below.
4. The above information does not require any connectivity to third-party systems (it is self-sustained)

For the sake of abundant clarity, it will be understood that the SATCOM system must know the platform orientation in order to direct the antenna dish toward the satellite (for the case where a non-auto-pointing antenna is installed). However, the platform orientation need not be (and generally is not) transmitted to the ground station and therefore basic C2 information may be constituted by only A. (Geo-position) and C. (Self-identification).

Therefore, the SATCOM MODEM may encapsulate the above self-sustained information required to operate the SATCOM system itself into/within the MODEM's Layer 2 without affecting the higher OSI layers, meaning that:
1. The C2 information can be sent within any transmitted frame/packet, e.g. transmitted along a video/audio stream.
2. It can be sent without Payload, in case that there is insufficient traffic on which to “hitchhike”.
3. The timing and the decision on which frames/packets the C2/C4I information is to be sent can be determined solely by the SATCOM system in accordance with its own QOS mechanisms, thus, providing optimized link transmission regarding C2/C4I and third party DATA within the same link.

Additional C2/C4I information from a third party may also be incorporated into Layer 2, e.g., fuel level values, health status and such like, which constitutes extended C2 information that is not required by the SATCOM system itself, but may be received from the relevant platform entities and be incorporated within the SATCOM modem info as C2/C4I. Third-party C2/C4I information it is not limited to be incorporated at Layer 2 and may be sent in any of the higher OSI layers. This method/invention provides the highest level of efficiency for transmission/exchange of C2/C4I information as the information is embedded into the lower layers of the communication system.

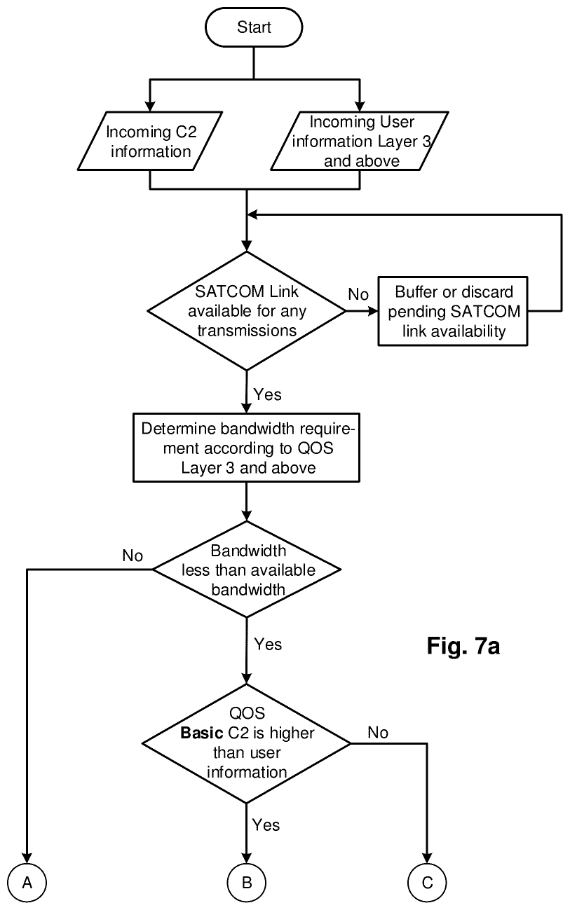

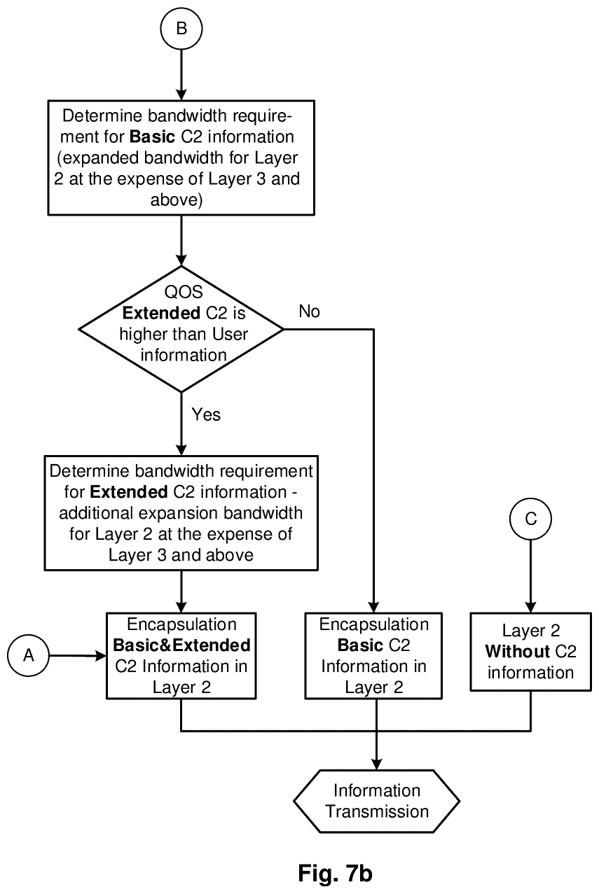

FIGS. 7a and 7b are a flow chart showing operation of the SATCOM controller 25 for implementing the above scheme according to an embodiment the invention. The controller 25 receives from the platform bus or the antenna the incoming C2 information together with the user information on Layer 3 or above. It checks whether there is an available SATCOM transmission link. If not, it buffers or discards the incoming information pending availability of a SATCOM transmission link.

If or when there is an available SATCOM transmission link, the controller 25 determines the required bandwidth according to a predetermined QoS for transmission of both the incoming C2 and payload data on Layer 3 or higher. If the required bandwidth is less than the available bandwidth, this means that there is sufficient bandwidth to send both the payload data and the C2 information. Alternatively, if the bandwidth is fully occupied, the controller checks which has the higher priority according to the defined QOS—the basic C2 information or the user information. If the basic C2 has the higher priority, then the controller redetermines bandwidth, giving priority to the C2 information transmitted in Layer 2 at the expense of the user information in Layer 3 or higher. What this means in practice is that, subject to partial bandwidth availability, only partial user information will be sent i.e., some packets will need to be omitted from the current transmission and sent in a subsequent transmission. In this case, the controller checks whether the extended C2 information has higher priority according to the defined QoS than the user information. If so, it further determines bandwidth to allow for transmission of extended C2 information in Layer 2 at the expense of the user information in Layer 3 or higher and the modem transmits both basic and extended C2 in Layer 2 (and partial user information in Layer 3 or higher). If the user information has higher priority than the basic C2 information, the Layer 2 information is transmitted without the basic C2 information. Alternatively, if the user information has higher priority than the extended C2 information but lower than basic C2 information, then only the basic C2 information is encapsulated in Layer 2 and partial user information is transmitted in Layer 3 or higher.

By way of example, basic C2 Payload can be incorporated within the Layer 2 header as follows:
1. Self Identification: 2 Bytes
2 Platform Geo-location 8 Bytes (Longitude: 4 Bytes, Latitude: 4 Bytes)
3. Platform Orientation 16 Bytes (True Heading: 4 Bytes, Pitch: 4 Bytes, Roll: 4 Bytes)

The total number of bytes thus required is 2+8+4+4+4=26 Bytes

It can be even “slimmer” if “Platform Orientation” is not sent as part of the basic header.

It will also be understood that the SATCOM controller may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for providing supplemental data including real-time spatial location of a mobile platform to a receiving node via a satellite without requiring either a third-party dedicated command and control data system or a dedicated channel for command and control data, the method comprising:
(a) obtaining at a transceiver a real-time spatial location of the mobile platform either directly from a pointing antenna or from a navigational system (EGI) coupled to a platform bus;
(b) for each transmission time-slot allocated by the transceiver for transmitting data pertaining to a SATCOM service, determining whether data pertaining to the SATCOM service awaits transmission; and if so:
i) determining whether there is available bandwidth for transmitting the supplemental data together with data pertaining to the SATCOM service;
ii) if there is sufficient available bandwidth, transmitting from the transceiver the supplemental data together with the data pertaining to the SATCOM service; and
(c) if, for any given time-slot, no data pertaining to the SATCOM service awaits transmission, then transmitting from the transceiver the supplemental data on its own.

2. The method according to claim 1, wherein the supplemental data further includes.an ID of the mobile platform.

3. The method according to claim 1, wherein the transceiver determines available bandwidth based on a defined Quality of Service (QOS).

4. The method according to claim 3, wherein the QoS is configurable.

5. The method according to claim 1, further comprising giving priority to either the supplemental data or the data pertaining to the SATCOM service based on their respective QoS if there is insufficient available bandwidth to transmit both.

6. The method according to claim 1, further comprising encapsulating the supplemental data into the transceiver's Layer 2 control data without affecting the higher OSI layers, thereby allowing supplemental data to be conveyed within any transmitted frame/packet.

7. The method according to claim 1, further comprising receiving the real-time spatial location of the mobile platform from an auto-pointing antenna.

8. A computer-readable medium storing program code instructions, which when executed by a computer processor are configured to implement the method of claim 1.

9. A mobile satellite communication (SATCOM) terminal providing supplemental data including real-time spatial location of a mobile platform to a receiving node via a communications satellite without requiring a third-party dedicated command and control data system or a dedicated channel for command and control; the mobile SATCOM terminal comprising:
a transceiver for transmitting and receiving data pertaining to a SATCOM service,
the transceiver including a modem configured to modulate an outgoing RF carrier signal with data to be relayed to the communications satellite and to demodulate a received RF signal to extract data relayed by the communications satellite, and
a connector for coupling to the modem a pointing antenna for pointing toward the communications satellite;
the transceiver further including a controller coupled to the modem and to the platform bus and being configured to:
(a) determine for each transmission time-slot, determining whether data pertaining to the SATCOM service awaits transmission, and if so:
i) determine whether there is available bandwidth for transmitting the supplemental data of the platform together with data pertaining to the SATCOM services;
ii) if there is sufficient available bandwidth, transmit from the transceiver the real-time supplemental data together with the data pertaining to the SATCOM service; otherwise:
(b) if, for any given time-slot, no data pertaining to the SATCOM service awaits transmission, then transmit from the transceiver the real-time spatial location on its own.

10. The mobile SATCOM terminal according to claim 9, wherein the supplemental data further includes.an ID of the mobile platform.

11. The mobile SATCOM terminal according to claim 9, further comprising:
a navigational data bus for receiving real-time navigational data (EGI) from the mobile platform.

12. The mobile SATCOM terminal according to claim 9, wherein the pointing antenna is auto-pointing.

13. The mobile SATCOM terminal according to claim 12, wherein the controller receives the geo-position of the mobile platform directly from the auto-pointing antenna.

14. The mobile SATCOM terminal according to claim 9, wherein the transceiver is configured to determine available bandwidth based on a defined Quality of Service (QoS).

15. The mobile SATCOM terminal according to claim 14, further comprising a user-interface for allowing the QoS to be defined by an end-user.

16. The mobile SATCOM terminal according to claim 14, wherein the controller is configured to give priority to either the supplemental data or the data pertaining to the SATCOM service based on their respective QoS if there is insufficient available bandwidth to transmit both.

17. The mobile SATCOM terminal according to claim 9, wherein the controller is configured to encapsulate the real-time supplemental data into the transceiver's Layer 2 control data without affecting the higher OSI layers, thereby allowing supplemental data to be conveyed within any transmitted frame/packet.
